(19) United States
(12) Patent Application Publication
(10) Pub. No.: US 2015/0249891 A1
(43) Pub. Date: Sep. 3, 2015

(54) MICROPHONE PACKAGE

(71) Applicant: SAMSUNG ELECTRO-MECHANICS CO., LTD., Suwon (KR)

(72) Inventors: Tae Hyun KIM, Suwon (KR); Jong Woo HAN, Suwon (KR); Heung Woo PARK, Suwon (KR)

(73) Assignee: SAMSUNG ELECTRO-MECHANICS CO., LTD., Suwon (KR)

(21) Appl. No.: 14/592,243

(22) Filed: Jan. 8, 2015

(30) Foreign Application Priority Data
Mar. 3, 2014 (KR) 10-2014-0024933

(51) Int. Cl. H04R 23/00

(52) U.S. Cl. CPC H04R 23/00

(57) ABSTRACT

The microphone package includes: a package substrate including a lead frame and an insulating portion; and an acoustic device mounted on the package substrate and having a space formed in a lower surface thereof, wherein the package substrate includes an acoustic space connected to the space of the acoustic device.

### CROSS-REFERENCE TO RELATED APPLICATION

This application claims the priority and benefit of Korean Patent Application No. 10-2014-0024933 filed on Mar. 3, 2014, with the Korean Intellectual Property Office, the disclosure of which is incorporated herein by reference.

### BACKGROUND

The present disclosure relates to a microphone package, and more particularly, to a microphone package capable of being easily manufactured.

Recently, as the volumes of electronic products such as cellular phones, laptop computers, and the like, have gradually decreased and demand for improvements in the performance of electronic products has gradually increased, volumes of components embedded in such electronic products have gradually been decreased. On the other hand, demand for improvements in the performance of such components has increased.

In the field of microphones, important components in many electronic products, a large number of products have been developed. An example of such a product is a micro electro mechanical systems (MEMS) microphone mass-produced using semiconductor manufacturing processing technology.

Generally, in the related art, a microphone in which an MEMS acoustic device is mounted on a printed circuit board has been used. Therefore, a printed circuit board optimized for microphones should be manufactured, and thus, there has been a limitation in decreasing a manufacturing costs and product unit price. In addition, a manufacturing process may be relatively complicated.

Therefore, a microphone package capable of being manufactured relatively easily and at reduced cost has been demanded.

### RELATED ART DOCUMENT

(Patent Document 1) Korean Utility Model Laid-Open Publication No. 2008-0005779

### SUMMARY

An aspect of the present disclosure may provide a microphone package that does not include a printed circuit board.

According to an aspect of the present disclosure, a microphone package may include: a package substrate including a lead frame and an insulating portion; and an acoustic device mounted on the package substrate and having a space formed in a lower surface thereof, wherein the package substrate includes an acoustic space connected to the space of the acoustic device.

The package substrate may further include: a seating portion having the acoustic device seated thereon; and a plurality of leads electrically connected to the acoustic device.

The microphone package may further include a cover accommodating the acoustic device therein and attached to the package substrate.

The package substrate may further include a conductive edge part bonded to the cover.

The lead frame of the package substrate may include: the plurality of leads electrically connected to the acoustic device; and an edge part formed along an outer edge of the package substrate and electrically connected to a cover attached to the package substrate.

The lead frame may include the seating portion having the acoustic device mounted thereon.

The insulating portion may be formed between the leads, the edge part, and the seating portion to secure insulation between the leads, the edge part, and the seating portion.

The insulating portion may include the seating portion having the acoustic device mounted thereon.

The acoustic space may be formed below a seating portion.

The package substrate may further include at least one support part formed in the acoustic space and supporting the seating portion.

The support part may be formed while connecting at least two positions on inner walls forming the acoustic space.

The support part may have a triangular shape and may have two sides each connected to a lower surface of the seating portion and a side wall of the acoustic space.

The support part may have a protrusion shape in which the support part protrudes downwardly from a lower surface of the seating portion.

The seating portion may be disposed above a plane formed by the leads.

The package substrate may be formed of a single layer substrate by the lead frame.

According to another aspect of the present disclosure, a microphone package may include: a package substrate including a lead frame and an insulating portion and formed as a single layer; and at least one electronic component mounted on the package substrate.

The package substrate may have an acoustic space formed in one surface thereof, the acoustic space forming a back volume of an acoustic device and having a groove shape.

The acoustic space may be formed in the lead frame or the insulating portion.

According to another aspect of the present disclosure, a microphone package may include: at least one electronic component; and a package substrate formed as a single layer and including a plurality of leads electrically connected to the electronic component and a seating portion having the electronic component seated thereon and formed of an insulating material.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional view of a microphone package according to an exemplary embodiment in the present disclosure;

FIG. 2 is a cross-sectional view taken along line A-A of FIG. 1;

FIG. 3 is a cross-sectional view schematically showing a microphone package according to another exemplary embodiment in the present disclosure;

FIG. 4 is a cross-sectional view schematically showing a microphone package according to another exemplary embodiment in the present disclosure;

FIG. 5 is a cross-sectional view taken along line A-A of FIG. 4;

FIG. 6 is a cross-sectional view schematically showing a microphone package according to another exemplary embodiment in the present disclosure;

FIG. 7 is a cross-sectional view taken along line A-A of FIG. 6;

FIG. 8 is a cross-sectional view schematically showing a microphone package according to another exemplary embodiment in the present disclosure;

FIG. 9 is a cross-sectional view taken along line A-A of FIG. 8;

FIG. 10 is a cross-sectional view schematically showing a microphone package according to another exemplary embodiment in the present disclosure; and

FIG. 11 is a cross-sectional view taken along line A-A of FIG. 10.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

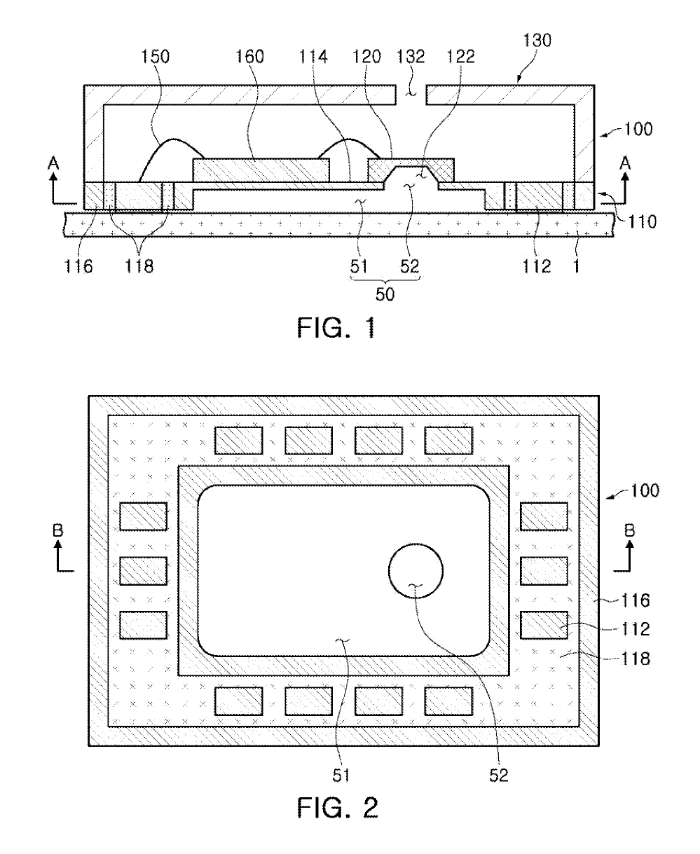

FIG. 1 is a cross-sectional view of a microphone package according to an exemplary embodiment in the present disclosure; and FIG. 2 is a cross-sectional view taken along line A-A of FIG. 1. Here, FIG. 1 shows a cross section taken along line B-B of FIG. 2.

Referring to FIGS. 1 and 2, a microphone package 100 according to the present exemplary embodiment may include an acoustic device 120, an electronic device 160, a cover 130, and a package substrate 110. In addition, the microphone package 100 may further include other devices required for operating the acoustic device 120.

The microphone package 100 may be mounted in a portable electronic apparatus, sense a sound including an audio, and convert the sensed sound into an electrical signal.

Hereinafter, main components of the microphone package 100 will be described.

The acoustic device 120 may be mounted on one surface of the package substrate 110.

The acoustic device 120 may be a general silicon condenser microphone device, and may be manufactured by a micro electro mechanical systems (MSMS).

The acoustic device 120 may convert a sound into an electrical signal using a capacitance changed depending on movement of a diaphragm vibrating by the sound. To this end, the acoustic device 120 may include a diaphragm and a back plate, and have a groove 122 formed inwardly (or upwardly) in a lower surface thereof.

Here, the groove 122 may be a back cavity included in the acoustic device 120 itself.

In addition, the acoustic device 120 may be mounted on one surface of a package substrate 110 to be described below in a form in which it closes an opening 52 of the package substrate 110. Here, the opening 52 may be adhered to a lower surface of the acoustic device 120, that is, an inlet of the groove 122 so as to be adjacent thereto.

Therefore, when the acoustic device 120 is mounted on the package substrate 110, the opening 52 may be closed by the acoustic device 120. As a result, a space including the back capacity of the acoustic device 120 may be prepared.

The electronic device 160 may be mounted on one surface of the package substrate 110, similar to the acoustic device 120.

The electronic device 160 may be an application-specific integrated circuit (ASIC). Therefore, the electronic device according to an exemplary embodiment in the present disclosure is not limited thereto, but may be other general electronic devices or semiconductor devices.

The acoustic device 120 and the electronic device 160 may be directly mounted on electrode pads of the package substrate 110 or be electrically connected to the package substrate 110 through a bonding wire, or the like.

The cover 130 may have a shape of a cap having an accommodating space formed therein, and be formed of a metal. However, the cover 130 is not necessarily formed of the metal, but may be formed of a mixture containing metal powders, if necessary.

The cover 130 may be bonded to an edge part 116 of the package substrate 110 in a form in which it covers the acoustic device 120 and the electronic device 160. In addition, the cover 130 may be electrically connected to the edge part 116, and may also be electrically connected to a ground of the package substrate 110, if necessary.

Therefore, the acoustic device 120 and the electronic device 160 may be protected from a harmful electromagnetic wave through the cover 130.

In addition, the cover 130 may have at least one acoustic hole 132 formed therein. The acoustic hole 132 may be used as a path through which the sound is introduced or discharged.

As the package substrate 110, a single layer substrate using a lead frame may be used.

The package substrate 110 according to the present exemplary embodiment may include lead frames 112, 116, and 114 formed of a conductive material and an insulating portion 118 formed of an insulating material. That is, the package substrate 110 according to the present exemplary embodiment may be implemented by forming the insulating portion 118 using the insulating material in the lead frames 112 and 116 having a plurality of leads 112 and then removing portions connecting the leads 112 to each other.

In the package substrate 110 according to the present exemplary embodiment, a seating portion 114 on which electronic components 120 and 160 are seated by the lead frames 112, 116, and 114, the leads 112, and the edge part 116 may be formed. In addition, the insulating portion 118 filled with an insulating material may be formed in spaces between the seating portion 114, the leads 112, and the edge part 116.

The seating portion 114 may have one or more electronic components 120 and 160 seated thereon. Since the seating portion 114 according to the present exemplary embodiment is formed of a conductive material, an insulating layer (not shown) may be formed on an upper surface of the seating portion 114, if necessary, in order to insulate the seating portion 114 from the electronic components 120 and 160.

Here, the electronic components 120 and 160 may include both of a passive device and an active device. In addition, the electronic components 120 and 160 may include both of the acoustic device 120 and the electronic device 160.

The leads 112 may be disposed so as to be spaced apart from the seating portion 114, and the insulating portion 118 may be disposed between the leads 112 and the seating portion 114 to maintain electrical insulation between the leads 112 and the seating portion 114. However, the present disclosure is not limited thereto. That is, in the case in which at least one lead 112 is used as a ground terminal, the corresponding lead 112 may also be electrically connected to the seating portion 114 or the edge part 116.

One surfaces of the leads 112 may serve as electrode pads through which the acoustic device 120 or the electronic device 160 is electrically connected to the package substrate. Here, the electrical connection may be made by a bonding wire 150.

In addition, the other surfaces, that is, lower surfaces, of the leads 112 may serve as external terminals through which the package substrate 110 is electrically connected to a main substrate 1.

The edge part 116 may be continuously formed along an outer edge of the package substrate 110. However, the edge part 116 is not limited to being formed as described above, but may also be discontinuously formed, if necessary.

A cover 130 to be described below may be bonded onto the edge part 116. Therefore, the edge part 116 may be formed at a width corresponding to a thickness of the cover 130, but is not limited thereto. In addition, as described above, the edge part 116 may be configured so as to maintain the insulation between the leads 112 and the seating portion 114. The lead 112 and the seating portion 114 may be electrically connected to each other for the ground, or the like.

In addition, the package substrate 110 according to the present exemplary embodiment may include an acoustic space 51 expanding the back cavity of the acoustic device 120 described above.

The acoustic space 51 may have various shapes as long as an empty space may be formed. The case in which a space is formed in a lower surface of the seating portion 114 of the package substrate 110 has been described by way of example in the present exemplary embodiment.

Therefore, the seating portion 114 may be formed at a thickness thinner than that of the lead 112 or the edge part 116.

The acoustic space 51 may be formed by performing press working on the lead frame, that is, the seating portion 114, in a process of manufacturing the package substrate 110. That is, since the acoustic space 51 may be formed by performing the press working on the seating portion 114 in a process of bending and punching the lead frame, the package substrate 110 may be very easily manufactured.

In addition, the acoustic space 51 according to the present exemplary embodiment may include at least one opening 52 opened as a device mounting surface of the package substrate 110.

The package substrate 110 as described above may be mounted on the main substrate 1. For example, the leads 112 of the package substrate 110 may be bonded to the main substrate 1 through a conductive adhesive so as to surface-contact the main substrate 1, such that the package substrate 110 may be electrically connected to the main substrate 1.

However, the present disclosure is not limited thereto, but may be variously modified. For example, the package substrate 110 may be electrically connected to the main substrate 1 through a solder ball, a solder bump, or the like, or through a bonding wire.

In the microphone package 100 according to the present exemplary embodiment configured as described above, the package substrate 110 may be configured using the lead frames. Therefore, the package substrate 110 may be more easily manufactured and a manufacturing cost of the package substrate 110 may be further decreased, as compared with the related art in which a printed circuit board is used.

In addition, the acoustic space 51 may be formed at a lower portion of the package substrate 110 and be connected to a space 122 formed in the acoustic device 120.

Therefore, an entire size of the back cavity of the acoustic device 120 may be increased without changing an entire volume of the microphone package 100, such that performance of the microphone package 100 may be improved.

Meanwhile, a microphone package according to the present disclosure is not limited to the above-mentioned exemplary embodiment, but may be variously modified.

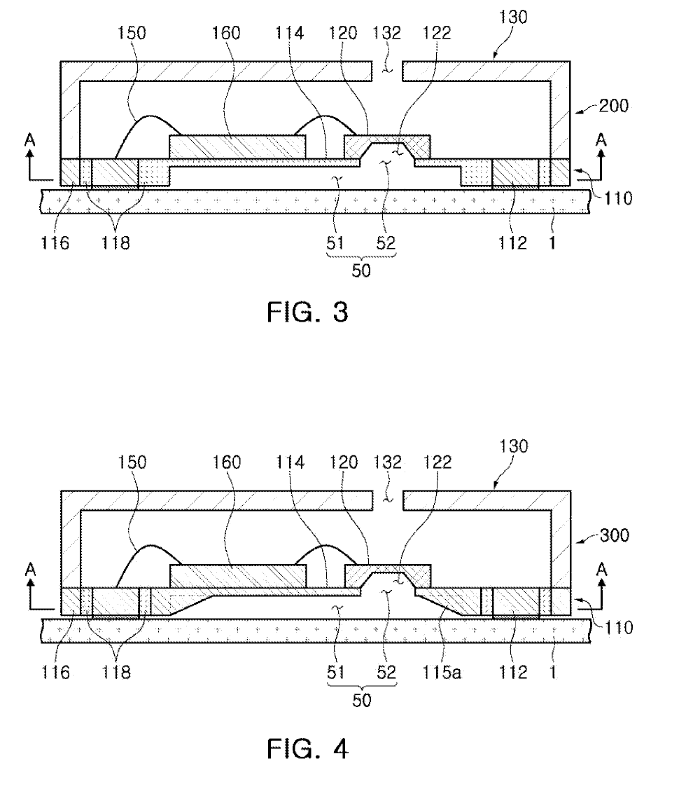

FIG. 3 is a cross-sectional view schematically showing a microphone package according to another exemplary embodiment in the present disclosure.

Referring to FIG. 3, a microphone package 200 according to the present exemplary embodiment may be similar to the microphone package according to the above-mentioned exemplary embodiment except for a structure of the package substrate 110. Therefore, a detailed description for the same components as those of the microphone package according to the above-mentioned exemplary embodiment will be omitted, and a structure of the package substrate 110 will be described in more detail.

In the microphone package 200 according to the present exemplary embodiment, the seating portion 114 on which the electronic components 120 and 160 are mounted may be formed by the insulating portion 118. Therefore, in the present exemplary embodiment, the lead frames 112 and 116 may include only the leads 112 and the edge part 116 except for the seating portion 114.

In this case, since the seating portion 114 is formed of an insulating material, there is no risk that the electronic components 120 and 160 will be electrically connected to the seating portion 114, such that insulation between the package substrate 110 and the electronic components 120 and 160 may be more easily secured.

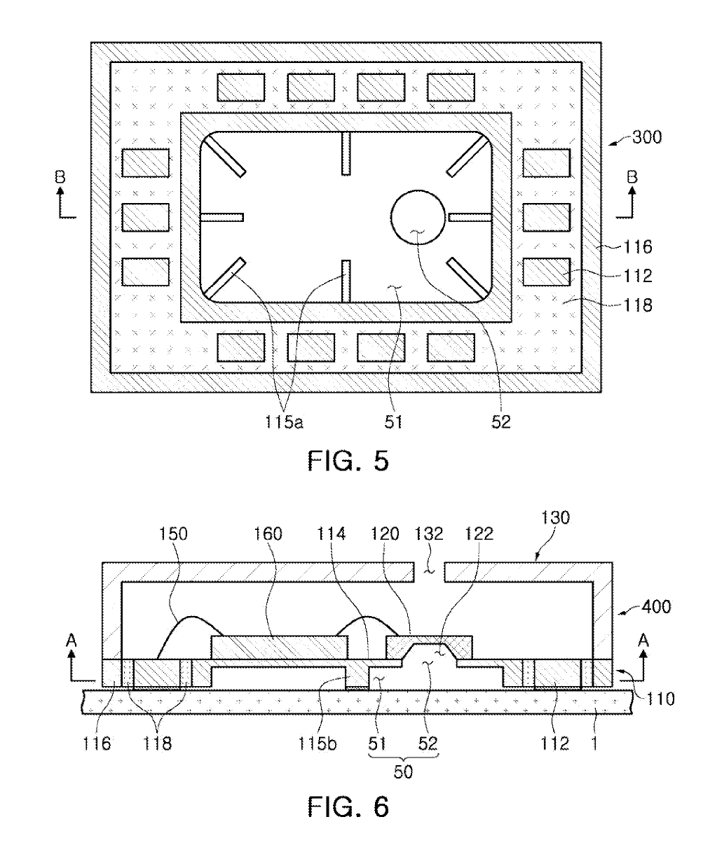

FIG. 4 is a cross-sectional view schematically showing a microphone package according to another exemplary embodiment in the present disclosure; and FIG. 5 is a cross-sectional view taken along line A-A of FIG. 4. In addition, FIG. 5 shows across section taken along line B-B of FIG. 4.

Referring to FIGS. 4 and 5, a microphone package 300 according to the present exemplary embodiment may be similar to the microphone package described above and shown in FIG. 1 except that it further includes support parts 115a formed in the acoustic space 51.

As described above, since the acoustic space 51 is formed below the seating portion 114 in the package substrate 110 according to the present exemplary embodiment, the seating portion 114 may be formed at a thickness relatively thinner than that of the lead 112, or the like. Therefore, the package substrate 110 may be easily damaged due to external force or be warped due to weights, or the like, of the electronic components 120 and 160.

Therefore, in order to solve this disadvantage, at least one support part 115a may be formed in the acoustic space 51.

The support part 115a may have a shape in which it connects at least two positions on inner walls forming the acoustic space 51 having a groove shape to each other. For example, the support part 115a may have a triangular shape in which two sides thereof are connected to a lower surface of the seating portion 114 and a side wall of the acoustic space 51.

A plurality of support parts 115a may be disposed depending on a size or a shape of the acoustic space 51. In addition, a size of the support part 115a protruding inwardly of the acoustic space 51 may be variously set depending on a size, a depth, or the like, of the acoustic space 51.

As described above, since the microphone package 300 according to the present exemplary embodiment includes the support part 115a, even in the case in which the seating portion 114 is formed at a thin thickness, a phenomenon that the seating portion 114 is bent or moved toward the acoustic space 51 may be suppressed.

Meanwhile, although the case in which the plurality of support parts 115a having the triangular shape are formed along sides of the acoustic space 51 has been described by way of example in the present exemplary embodiment, the present disclosure is not limited thereto. For example, the support part may also have a rectangular shape or a polygonal shape. In addition, various modifications may be made, if necessary. For example, the support part may be configured so as to be connected to three inner walls while traversing the acoustic space 51.

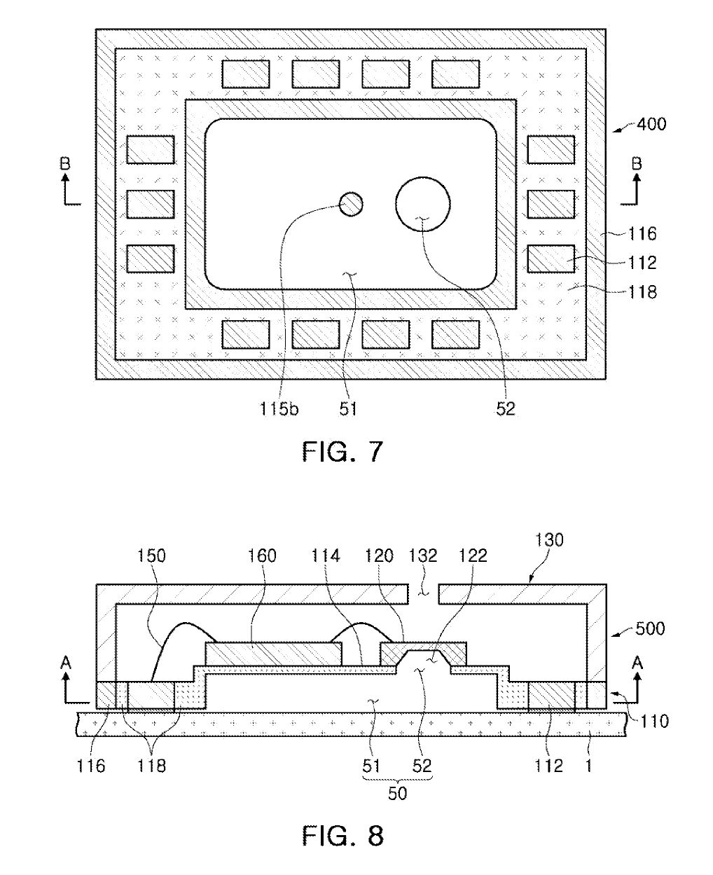

FIG. 6 is a cross-sectional view schematically showing a microphone package according to another exemplary embodiment in the present disclosure; and FIG. 7 is a cross-sectional view taken along line A-A of FIG. 6. In addition, FIG. 6 shows across section taken along line B-B of FIG. 7.

Referring to FIGS. 6 and 7, a microphone package 400 according to the present exemplary embodiment may be similar to the microphone package described above and shown in FIG. 1 except that it further includes a support part 115b formed in the acoustic space 51.

Particularly, the support part 115b according to the present exemplary embodiment may have a protrusion (or pillar) shape in which it protrudes downwardly from one inner wall, that is, a lower surface of the seating portion 114, rather than two inner walls forming the acoustic space 51.

Here, the support part 115b may protrude so that a distal end thereof is coplanar with a lower surface of the package substrate 110.

Through the above-mentioned configuration, when the microphone package 400 according to the present exemplary embodiment is mounted on the main substrate 1, the support part 115b of the package substrate 110 may support the seating portion 114 while having the distal end contacting the main substrate 1. Therefore, even in the case in which the seating portion 114 is formed at a thin thickness, a phenomenon that the seating portion 114 is bent or moved toward the acoustic space 51 may be prevented.

Meanwhile, although the case in which one support part 115b having a cylindrical shape is formed at the center of the acoustic space 51 has been described by way of example in the present exemplary embodiment, the present disclosure is not limited thereto, but may be variously modified, if necessary. For example, a plurality of support parts may protrude in the acoustic space 51 or the support part may have a polygonal pillar shape.

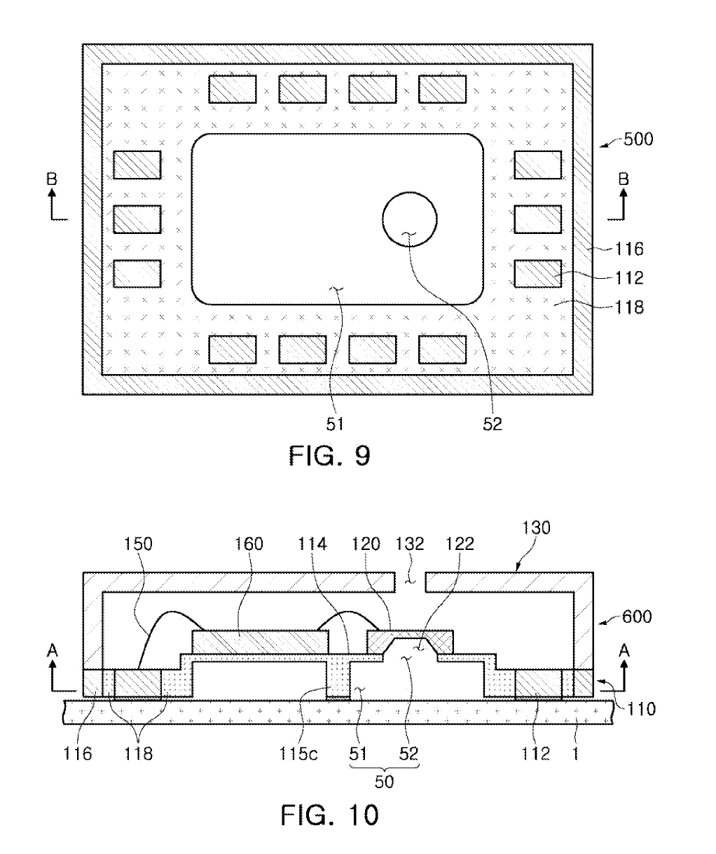

FIG. 8 is a cross-sectional view schematically showing a microphone package according to another exemplary embodiment in the present disclosure; and FIG. 9 is a cross-sectional view taken along line A-A of FIG. 8. In addition, FIG. 8 shows across section taken along line B-B of FIG. 9.

Referring to FIGS. 8 and 9, a microphone package 500 according to the present exemplary embodiment may be similar to the microphone package described above and shown in FIG. 3 except that a size of the acoustic space 51 is further extended.

In detail, the seating portion 114 may be disposed above a plane formed by the lead part 112 or the edge part 116, such that a depth of the acoustic space 51 may be extended.

This configuration may be implemented by forming the seating portion 114 at a position higher than the leads 112 in a process of forming (for example, injection-molding, or the like) the insulating portion 118 in the lead frames.

Through the above-mentioned configuration, in the microphone package 500 according to the present exemplary embodiment, a wider acoustic space 51 may be secured, such that a size of the back cavity may be further extended.

Meanwhile, although the case in which the seating portion 114 is formed by the insulating portion 118 has been described by way of example in the present exemplary embodiment, the present disclosure is not limited thereto, but may be variously modified. For example, as shown in FIG. 1, the package substrate 110 may also have a shape similar to that of the present exemplary embodiment by forming the seating portion 114 using the lead frame and press-bending the seating portion 114 in a process of manufacturing the lead frame.

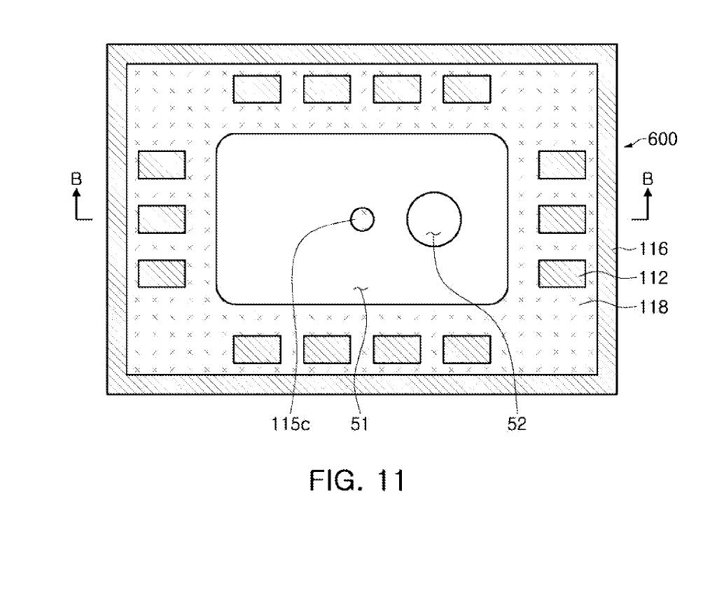

FIG. 10 is a cross-sectional view schematically showing a microphone package according to another exemplary embodiment in the present disclosure; and FIG. 11 is a cross-sectional view taken along line A-A of FIG. 10. In addition, FIG. 10 shows a cross section taken along line B-B of FIG. 11.

Referring to FIGS. 10 and 11, a microphone package 600 according to the present exemplary embodiment may be similar to the microphone package described above and shown in FIG. 8 except that it further includes a support part 115c formed in the acoustic space 51.

Particularly, the support part 115c according to the present exemplary embodiment may protrude in a pillar shape from a lower surface of the seating portion 114 formed by the insulating portion 118. Here, the support part 115c may protrude so that a distal end thereof is coplanar with a lower surface of the package substrate 110.

Through the above-mentioned configuration, when the microphone package 600 according to the present exemplary embodiment is mounted on the main substrate 1, the support part 115c of the package substrate 110 may support the seating portion 114 while having the distal end contacting the main substrate 1. Therefore, even in the case in which the seating portion 114 is formed at a thin thickness, a phenomenon that the seating portion 114 is bent or moved toward the acoustic space 51 may be suppressed.

Meanwhile, although the case in which one support part 115c having a cylindrical shape is formed at the center of the acoustic space 51 has been described by way of example in the present exemplary embodiment, the present disclosure is not limited thereto, but may be variously modified, if necessary. For example, a plurality of support parts 115c may protrude in the acoustic space 51 or the support part may have a polygonal pillar shape.

As set forth above, in the microphone packages according to exemplary embodiments of the present disclosure, the single layer package substrate may be formed and used based on the lead frame. Therefore, the package substrate may be more easily manufactured and a manufacturing cost of the package substrate may be further decreased, as compared with the related art in which a printed circuit board is used.

In addition, the acoustic space may be formed at the lower portion of the package substrate and be connected to the space formed in the acoustic device. Therefore, an entire size of the back cavity of the acoustic device may be increased without changing an entire volume of the microphone package, such that performance of the microphone package may be improved.

While exemplary embodiments have been shown and described above, it will be apparent to those skilled in the art that modifications and variations could be made without departing from the scope of the present invention as defined by the appended claims.

What is claimed is:

1. A microphone package comprising:
a package substrate including a lead frame and an insulating portion; and
an acoustic device mounted on the package substrate and having a space formed in a lower surface thereof,
wherein the package substrate includes an acoustic space connected to the space of the acoustic device.

2. The microphone package of claim 1, wherein the package substrate includes:
a seating portion having the acoustic device seated thereon; and
a plurality of leads electrically connected to the acoustic device.

3. The microphone package of claim 2, further comprising a cover accommodating the acoustic device therein and attached to the package substrate.

4. The microphone package of claim 3, wherein the package substrate further includes a conductive edge part bonded to the cover.

5. The microphone package of claim 2, wherein the lead frame of the package substrate includes:
the plurality of leads electrically connected to the acoustic device; and
an edge part formed along an outer edge of the package substrate and electrically connected to a cover attached to the package substrate.

6. The microphone package of claim 5, wherein the lead frame includes the seating portion having the acoustic device mounted thereon.

7. The microphone package of claim 6, wherein the insulating portion is formed between the leads, the edge part, and the seating portion to secure insulation between the leads, the edge part, and the seating portion.

8. The microphone package of claim 5, wherein the insulating portion includes the seating portion having the acoustic device mounted thereon.

9. The microphone package of claim 2, wherein the acoustic space is formed below the seating portion.

10. The microphone package of claim 9, wherein the package substrate further includes at least one support part formed in the acoustic space and supporting the seating portion.

11. The microphone package of claim 10, wherein the support part is formed while connecting at least two positions on inner walls forming the acoustic space.

12. The microphone package of claim 11, wherein the support part has a triangular shape and has two sides each connected to a lower surface of the seating portion and a side wall of the acoustic space.

13. The microphone package of claim 10, wherein the support part is formed in a protrusion shape in which the support part protrudes downwardly from a lower surface of the seating portion.

14. The microphone package of claim 9, wherein the seating portion is disposed above a plane formed by the leads.

15. The microphone package of claim 1, wherein the package substrate is formed of a single layer substrate by the lead frame.

16. A microphone package comprising:
a package substrate including a lead frame and an insulating portion and formed as a single layer; and
at least one electronic component mounted on the package substrate.

17. The microphone package of claim 16, wherein the package substrate has an acoustic space formed in one surface thereof, the acoustic space forming a back volume of the at least one electronic component and having a groove shape.

18. The microphone package of claim 17, wherein the acoustic space is formed in the lead frame or the insulating portion.

19. A microphone package comprising:
at least one electronic component; and
a package substrate formed as a single layer and including a plurality of leads electrically connected to the electronic component and a seating portion having the electronic component seated thereon and formed of an insulating material.
